(19) United States
(12) Patent Application Publication
(10) Pub. No.: US 2006/0194695 A1
(43) Pub. Date: Aug. 31, 2006

(54) Destabilized and catalyzed borohydrided for reversible hydrogen storage

(75) Inventor: Ming Au, Martinez, GA (US)

Correspondence Address: J. BENNETT MULLINAX, LLC, P. O. BOX 26029, GREENVILLE, SC, 29616-1029, US

(73) Assignee: Westinghouse Savannah River Co., LLC, Aiken, SC (US)

(21) Appl. No.: 11/343,048

(22) Filed: Jan. 30, 2006

Related U.S. Application Data
(63) Continuation-in-part of application No. 11/130,750, filed on May 17, 2005.
(60) Provisional application No. 60/605,177, filed on Aug. 27, 2004.

(51) Int. Cl. C01B 6/13

(52) U.S. Cl. 502/400; 423/286; 264/109; 264/118

(57) ABSTRACT

A hydrogen storage material and process is provided in which catalyzed alkali borohydride materials and partially substituted borohydride materials are created and which may contain effective amounts of catalyst(s) which include transition metal oxides, halides, and chlorides of titanium, zirconium, tin, vanadium, iron, cobalt and combinations of the various catalysts and the destabilization agents which include metals, metal hydrides, metal chlorides and complex hydrides of magnesium, calcium, strontium, barium, aluminum, gallium, indium, thallium and combinations of the various destabilization agents. When the catalysts and destabilization agents are added to an alkali borodydride such as a lithium borohydride, the initial hydrogen release point of the resulting mixture is substantially lowered. Additionally, the hydrogen storage material may be rehydrided with weight percent values of hydrogen of at least about nine percent.

### RELATED APPLICATIONS

This application is a continuation-in-part of U.S. Utility application Ser. No. 11/130,750, filed on May 17, 2005, and which claims the benefit of U.S. Provisional Application No. 60/605,177, filed on Aug. 27, 2004, the specifications of which are incorporated herein by reference.

### STATEMENT AS TO RIGHTS TO INVENTIONS MADE UNDER FEDERALLY SPONSORED RESEARCH AND DEVELOPMENT

This invention was made with Government support under Contract No. DE-AC0996-SR18500 awarded by the United States Department of Energy. The Government has certain rights in the invention.

### FIELD OF THE INVENTION

This invention is directed towards a hydrogen storage material and process of using the hydrogen storage material in which metal borohydrides may be catalyzed OR destabilized so as to achieve a lower hydrogen release start point of less than 100° C. Further, the present invention is directed to the catalyzed or destabilized borohydrides which may reversibly absorb and desorb hydrogen. A further aspect of the invention is directed to a process of incorporating catalysts or destabilized agents into a metal borohydride so as to achieve novel borohydride compositions having improved hydrogen release kinetics along with an ability to reversibly absorb and desorb hydrogen.

### BACKGROUND OF THE INVENTION

This invention relates to the use of borohydrides in hydrogen storage and release technologies. Borohydrides such as LiBH₄ can be used for hydrogen storage and energy systems making use of stored hydrogen. Borohydrides contain a large amount of hydrogen within their molecular structure. For example, LiBH₄ contains 18wt % hydrogen, an amount higher than any other known hydrogen storage material. Accordingly, borohydrides have great potential to be developed as hydrogen storage media.

Unfortunately, borohydrides release hydrogen at very high temperatures, with temperatures usually exceeding the melting point of the borohydrides. For example, commercially available LiBH₄ releases hydrogen above 400° C. In addition, the hydrogen release mechanism is typically irreversible for commercially available LiBH₄ in that the borohydride cannot be rehydrided.

It is known to use various borohydrides for specialized applications requiring a hydrogen storage material. For instance, U.S. Pat. No. 6,737,184 assigned to Hydrogenics Corporation, and which is incorporated herein by reference, discloses one release mechanism using LiBH₄ in which a solvent such as water is used to bring about the release of stored hydrogen. However, once released, the LiBH₄ cannot be easily rehydrided.

Similar aqueous based release reactions for borohydrides may also be seen in reference to U.S. Pat. Nos. 6,670,444; 6,683,025; and 6,706,909 all assigned to Millennium Cell and which are incorporated herein by reference. The cited references are all directed to aqueous-based reactions for releasing hydrogen from a borohydride. There is no discussion within the references of catalysts or material handling techniques that allow the reversible release of hydrogen from a metal borohydride containing solid compound.

It is also known in the art that borohydrides may release hydrogen through a thermal decomposition process. For instance, in U.S. Pat. No. 4,193,978 assigned to Comphenie Francaise de Raffinage and which is incorporated herein by reference, lithium borohydride is described as a hydrogen storage material which releases hydrogen during a thermal decomposition process. The reference states that aluminum may be added to the lithium borohydride to lower the reconstitution temperature and to increase the hydrogen capacity of the material. There is no discussion of catalysts or other materials or techniques designed to bring about a lower hydrogen release point temperature.

It has been reported in the article, “Hydrogen Storage Properties of LiBH₄”, Journal of Alloys & Compounds, 356-357 (2003) 515-520 by Zuttlel et al and which is incorporated herein by reference, that LiBH₄ may include a low temperature structure of an orthorhombic, space group having a hydrogen desorption value reportedly occurring at approximately 200° C. in the presence of SiO₂. However, an ability to rehydride the dehydrided lithium borohydride and the use of additives other than the SiO₂ in reducing the dehydriding temperature and isothermal dehydriding properties is not reported.

Currently, the art recognizes that borohydrides, when subjected to high temperatures, may decompose and release hydrogen at a point in excess of the borohydride's melting point of 280° C. Alternatively, borohydrides can also be used through an irreversible hydrolysis process to provide a source of hydrogen. However, there remains room for improvement and variation within the art directed to the use of borohydrides in hydrogen storage applications.

### SUMMARY OF THE INVENTION

It is one aspect of at least one of the present embodiments to provide for a mixture of a borohydride and an effective amount of a catalyst which reduces the temperature at which stored hydrogen gas is released from the borohydride mixture.

It is an additional aspect of at least one of the present embodiments of the invention to provide for an effective amount of a catalyst which, when added to a borohydride mixture, enables the resulting mixture to release hydrogen gas and to subsequently be rehydrided under conditions of temperature and pressure.

It is a further aspect of at least one of the present embodiments of the invention to provide for a hydrogen storage material comprising a mixture of an alkali borohydride with an effective amount of a catalyst selected from the group consisting of TiO₂, ZrO₂, SnO₂, TiCl₃, SiO₂, V₂O₃, Fe₂O₃, MoO₃, CoO, ZnO, transition metal oxides, halides, and combinations thereof.

It is a further aspect of at least one of the present embodiments of the invention to provide for a hydrogen storage material comprising a mixture of a borohydride, such as LiBH₄, with an effective amount of a catalyst selected from the group consisting of TiO₂, ZrO₂, SnO₂, TiCl₃, SiO₂, V₂O₃, Fe₂O₃, MoO₃, CoO, ZnO, transition metal oxides, halides, and combinations thereof.

It is a further aspect of at least one embodiment of the present invention to provide for destabilized metallic borohydrides having reduced dehydriding temperatures and improved hydrogen binding/release kinetics by providing a metal borohydride; substituting metal cations (such as Li⁺, Na⁺, and K⁺) of the metal borohydrides with metal cations having a lower metallic character (such as Mg⁺², Ca⁺², Sr⁺², and Ba⁺²), thereby lowering the stability of BH bonds in a tetrahedron [BH₄]⁻¹; optionally substituting boron atoms in the tetrahedron with other elements selected from the group consisting of Al, Ga, In, Ti, and combinations thereof; thereby providing a substituted metal borohydride having improved hydrogen kinetics.

It is a further aspect of at least one embodiment of the present invention to provide for a process of forming a metal borohydride comprising the steps of: providing a supply of LiBH₄; mixing with the LiBH₄ a substitution agent selected from the group consisting of metals (such as Mg, Ca, Sr, Ba, and Al by way of non-limiting examples), metal chlorides (such as MgCl₂, AlCl₃, CaCl₂, and TiCl₃, by way of non-limiting examples), metal hydrides (such as MgH₂, AlH₃, CaH₂, TiH₂, and ZrH₂ by way of non-limiting examples), complex hydrides (such as LiAlH₄, NaAlH₄, and Mg(AlH₄)₂ by way of non-limiting examples) and mixtures thereof; ball milling the LiBH₄ and one or more substitution agents; sintering the product of the ball milling at a temperature below the melting point of LiBH₄ and at a hydrogen atmosphere pressure higher than the decomposition pressure of LiBH₄ at said selected temperature, thereby achieving partial substitution by solid diffusion of a lithium component with at least one of said substitution agents, thereby providing a sintered block of partially substituted borohydride; physically reducing the sintered block by crushing and ball milling so as to achieve a nanoscale particle size; and optionally introducing a catalyst to said sintered block during the crushing and ball milling steps.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is a graph showing the dehydriding characteristics of the indicated catalyzed borohydrides and accompanying control LiBH₄.

FIG. 2 is a graph showing the rehydriding capability of the catalyzed borohydrides at 600° C. and 100 bar.

FIG. 3 is a graph setting forth the first and second cycle hydrogen release characteristics of LiBH₄ 75%-TiO₂ 25% at the indicated temperatures.

FIG. 4 is a graph setting forth desorption data for LiBH₄ 75%-TiO₂ 25% at respective temperatures of 400° C., 300° C., and 200° C.

FIG. 5 is an x-ray diffraction spectra setting forth the unique crystal structure of LiBH₄ 75%-TiO₂ 25% in comparison to a sample of LiBH₄.

FIG. 6 is a graph comparing dehydrogenation of the destabilized and commercial LiBH₄ materials.

FIG. 7 is a Raman spectra comparison between the destabilized and commercial LiBH₄ materials.

FIG. 8 is a graph setting forth the first, second, and third cycle hydrogen release characteristics of a partially substituted LiBH₄ in which the substituted material is LiBH₄ plus 0.2 molar Mg.

FIG. 9 is a graph comparing dehydrogenation of a destabilized LiBH₄ with a commercial LiBH₄ material.

FIG. 10 is a graph setting forth the desorption data for a partially substituted LiBH₄ material.

FIG. 11 is a graph showing the rehydriding capability of the partially substituted borohydride material at 600° C. and 70 bars of pressure.

FIG. 12 is a graph setting forth desorption data for a partially substituted LiBH₄ with the indicated catalyst.

FIG. 13 is a graph setting forth rehydriding capabilities of the partially substituted borohydride and indicated catalyst.

FIG. 14 is a graph setting forth desorption data for a partially substituted LiBH₄ with 0.2 molar aluminum.

FIG. 15 is a graph showing the rehydriding capability of the partially substituted LiBH₄ referred to in FIG. 14 at 600° C. and 100 bars of hydrogen pressure.

FIG. 16 is a graph setting forth desorption data for LiBH₄ plus 0.5 LiAlH₄.

FIG. 17 is a graph setting forth rehydriding capability of a LiBH₄ as partially substituted with 0.5 LiAlH₄.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

In accordance with the present invention, it has been found that borohydrides such as alkali borohydrides may be catalyzed with effective amounts of various oxides and chlorides of titanium, zirconium, tin along with transition metal oxides and other metal and non-metal oxides, halides, and combinations of catalysts so as to reduce the temperature release point for hydrogen. Additionally, the incorporation of effective amounts of catalysts in a mixture with the borohydrides has been found to permit the rehydriding of hydrogen into the mixture material under conditions of elevated temperatures and pressures.

TABLE 1

| | | Weight | Balls | Speed | Milling Time | | Temp | |
|---|---|---|---|---|---|---|---|---|
| Sample | Composition % | (g) | (φmm/#) | (rpm) | (h) | run/rest/cy | (C. °) | Atmosphere |
| 1 | 75 wt % LiBH₄ + 25 wt % TiO₂ | 1.00 | 11/3 | 600 | 20 | (1 × 0.5 × 20) | 25 | Ar |
| 2 | 75 wt % LiBH₄ + 25 wt % ZrO₂ | 1.00 | 11/3 | 600 | 20 | (1 × 0.5 × 20) | 25 | Ar |
| 3 | 75 wt % LiBH₄ + 25 wt % SiO₂ | 2.00 | 11/3 | 600 | 20 | (1 × 0.5 × 20) | 25 | Ar |
| 4 | 75 wt % LiBH₄ + 25 wt % SnO₂ | 2.00 | 11/3 | 600 | 20 | (1 × 0.5 × 20) | 25 | Ar |
| 5 | 75 wt % LiBH₄ + 25 wt % TiCl₃ | 2.00 | 11/3 | 600 | 20 | (1 × 0.5 × 20) | 25 | Ar |

As seen in reference to Table 1, the indicated weight percent of lithium borohydride was mixed with a 25wt % of the indicated oxide or chloride of Ti, Si, Zr, and/or Sn. The indicated amounts of the resulting compositions were subjected to a ball milling process using three 11 mm diameter tungsten carbide balls in conjunction with a Fritsch ball mill apparatus. Samples of lithium borohydrides dried in an inert argon atmosphere were transferred inside the argon glovebox to two 45 ml grinding jars of the Fritsch ball mill apparatus, which were then sealed for protection during transfer to the Fritsch ball mill apparatus. At all times during the ball milling process, the borohydride and respective catalysts were maintained in an inert argon atmosphere. The ball mill apparatus was operated at 600 rpms. The ball milling times, as indicated, extended up to 20 hours using a cycle of 1 hour run time followed by a half hour of rest. The ball milling apparatus was run at ambient temperatures of 25° C.

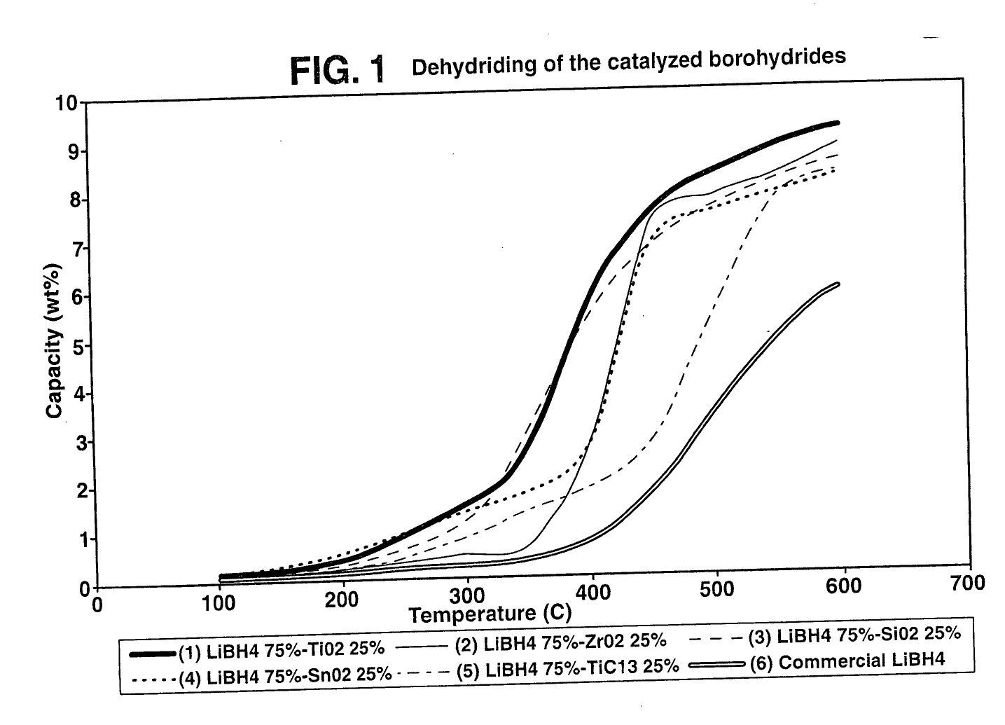

Following the ball milling process, mixture samples ranging from approximately 0.250 grams to approximately 0.500 grams were evaluated in a Sieverts volumetric apparatus using a Temperature Programmed Desorption (TPD) from ambient temperature to 600° C. with a heating rate of 5° C./min. The desorption conditions included a backpressure of P₀=5.4 mbar. The results of the hydrogen desorption are set forth in FIG. 1 as samples 1-5 corresponding to Table 1 along with the appropriate control of commercially available LiBH₄ (100%) (Sample 6).

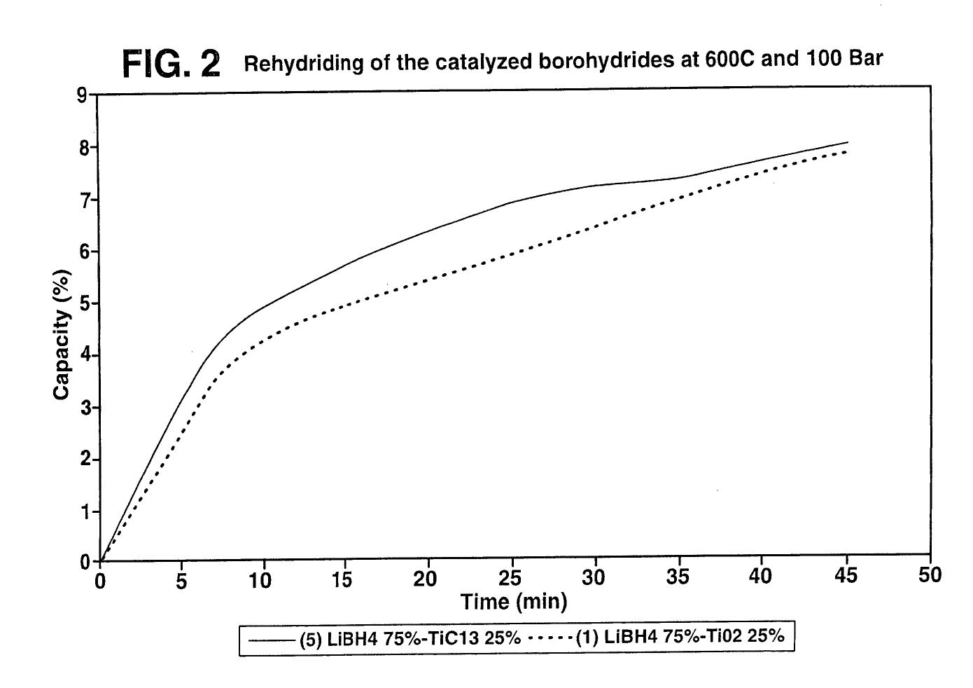

Following the hydrogen desorption, the desorbing material was rehydrided at 600° C. and 100 bar of hydrogen for 45 minutes. As indicated in FIG. 2, the percent of hydrogen absorbed for the indicated materials is reflected on the Y axis.

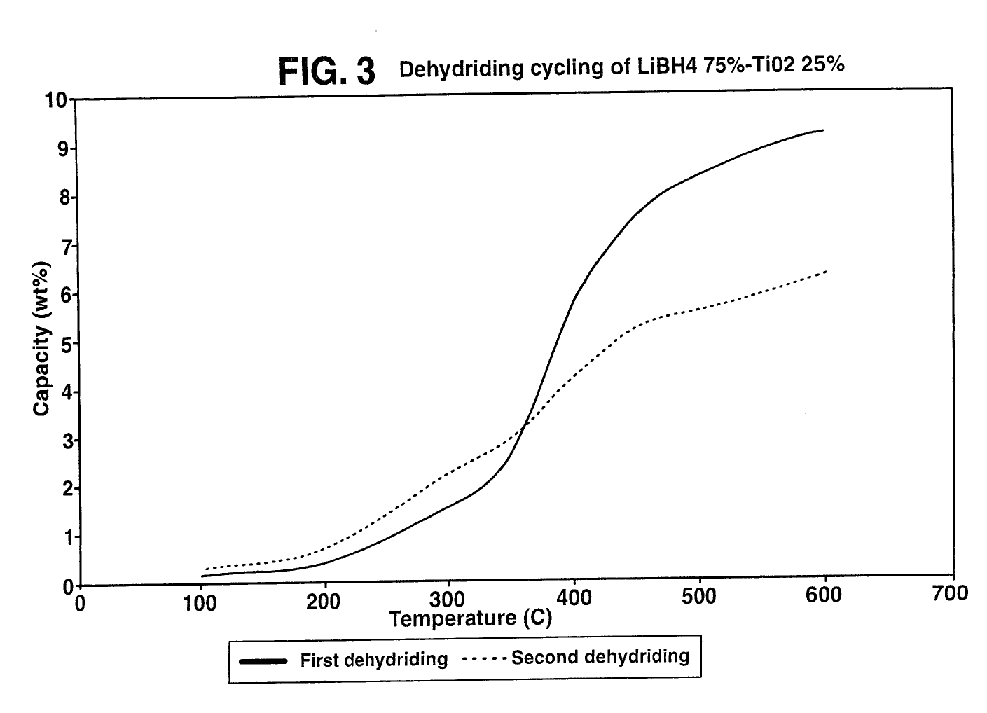

As seen in FIG. 3, the sample of LiBH₄ 75%-TiO₂ 25% exhibits reversible hydrogen cycling characteristics as indicated by the capacity in weight percent of the material in a first dehydriding and a second dehydriding cycle.

As indicated by the data set forth below, the catalyzed borohydride compounds exhibit a hydrogen release initiation temperature which is reduced from 400° C. to 200° C. Additionally, the catalyzed borohydrides have shown a reversible capacity of about 6wt % to about 9wt % hydrogen. However, as the catalyst amounts and ball milling processes are optimized, it is envisioned that cycles of rehydrating and dehydrating will result in the reversible release of even greater weight percent amounts of hydrogen. The ability to rehydride borohydrides at the demonstrated temperatures and pressures represents a significant improvement and advancement within the art. The reversible capacity for hydrogen storage, when combined with the demonstrated ability of reduced temperature release kinetics, are significant advancements within the area of hydrogen storage materials in particular for borohydrides.

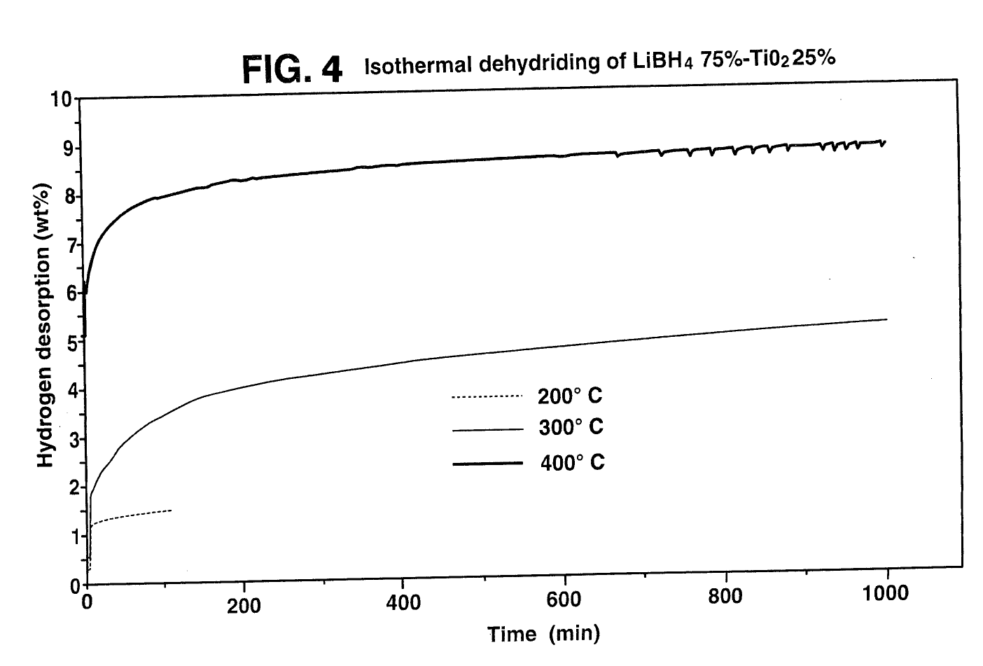

As seen in reference to FIG. 4, the sample 1 of LiBH₄ 75%-TiO₂ 25% desorbs 8.5wt %, 5.0wt %, and 1.5wt % hydrogen at 400° C., 300° C., and 200° C. respectively. It is expected that the lower dehydriding temperature and the higher dehydriding capacity are achievable through the optimization of the catalysts, catalyst loading and synthesis parameters.

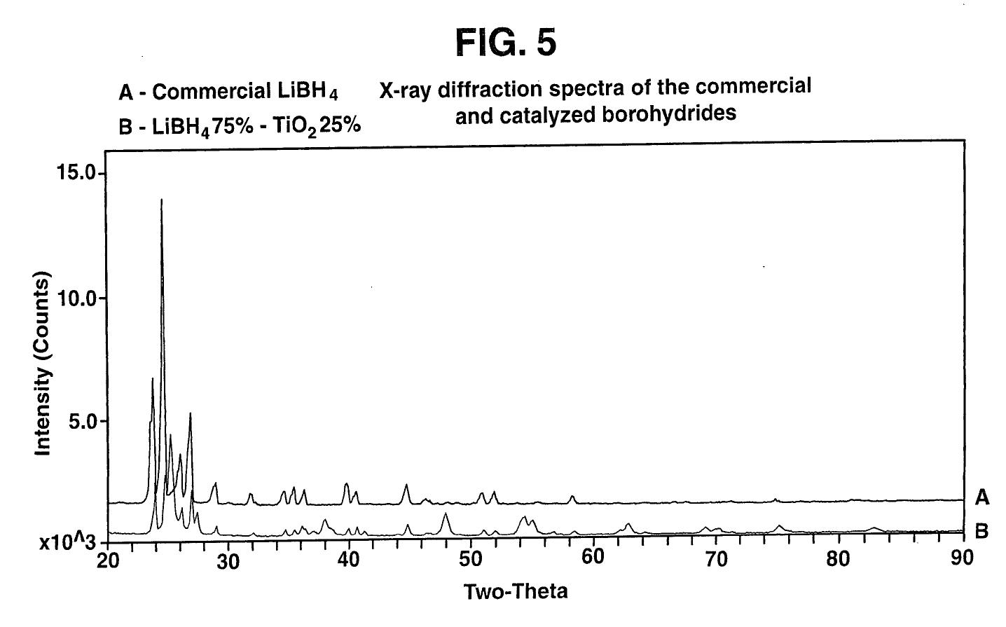

As seen in reference to FIG. 5, sample 1 of LiBH₄ 75%-TiO₂ 25% has a unique crystal structure that differs from the original LiBH₄.

As seen in reference to FIG. 1, five specific catalysts (samples 1-5) have been seen to be effective in reducing dehydrating temperatures and producing a reversible hydrogen storage material. It is recognized and understood that the operative amounts of catalysts and the conditions for combining the catalysts with the borohydrides have not been optimized. While 25wt % loadings of various catalysts have proven effective, as various catalysts are evaluated and optimized, it is believed that catalyst amounts as low as about 10wt % to as high as about 50wt % may offer optimal results. It is well within the skill level of one having ordinary skill in the art to use routine experimentation to determine the preferred and optimal amounts of catalysts using the techniques described herein and thereby determine the most effective weight percent amounts of catalyst.

Similarly, the equipment and resulting processes used to carry out the ball milling process as well as the Temperature Programmed Desorption (TPD) parameters can also be refined. Again, it is believed that variations in the ball milling process, such as the parameters of ball number, size, weight, and ball milling speed may be varied to achieve the desired results.

According to another aspect of at least one embodiment of the present invention, it has been found that the borohydrides, such as LiBH₄, NaBH₄, and KBH₄ may be modified through partial substitution with one or more destabilization agents to result in a lower dehydriding temperature and improved dehydriding and rehydriding kinetics. As used herein, the term “destabilization agent” includes an element or molecule which is partially substituted for either the lithium atom or the boron atom within a borohydride such as LiBH₄. A non-limiting example of some suitable substitution agents includes metals such as magnesium, aluminum; metal chlorides such as MgCl₂, CaCl₂, AlCl₃, TiCl₃, and FeCl₃; metal hydrides such as MgH₂, CaH₂, AlH₃, TiH₂, and ZrH₃; and complex hydrides such as LiAlH₄, NaAlH₄, and Mg(AlH₄)₂; and combinations thereof. While not wishing to be limited by theory, Applicant believes that the substitution agents, as seen by the non-limiting examples provided above, have less ionic character than the original metal borohydrides. As a result, the partial substitution of metal cations by cations having a lower ionic property reduces the ionic strength of the bond between the metal B and the hydrogen. The hydrogen atoms are thus more easily removed, indicative of the lower stability of the B—H bonds in the tetrahedrons [BH₄]⁻¹. It is further believed that the binding strength of the B—H bonds within the tetrahedron can be reduced when the boron atom is partially substituted by another element such as Al, Ga, In, Ti, Zr, or V.

As set forth below, it has been demonstrated that various metals, metal chlorides, metal hydrides, and other complex hydrides may be used as destabilization agents to substitute a percentage of either the Li atoms or B atoms in LiBH₄ resulting in lower dehydrating temperatures. It is also demonstrated that the partial destabilization may bring about improvements in dehydriding and rehydriding kinetics. A Mechano-Thermal Diffusion Process (MTDP) of achieving the partial substitution is as follows:

Step 1. A mixture of commercial LiBH₄ is combined with metals such as Mg Ca, Sr, Ba, and Al; metal chlorides such as MgCl₂, CaCl₂, SrCl₂, BaCl₃; metal hydrides such as MgH2, CaH₂, AlH₃; or other complex hydrides such as LiAlH₄, NaAlH₄, and Mg(AlH₄)₂; which are collectively ball milled to achieve a reduced particle size and bring about a homogeneous mixing of the materials.

Step 2. Following the initial ball milling and mixing, the resulting mixture is sintered at a temperature (300° C.) below the melting point of LiBH₄ at a given hydrogen atmosphere (100 bar) such that the hydrogen pressure is greater than the decomposition pressure of LiBH₄ at the reaction temperature. It is believed that partial substitution takes place through solid diffusion of the elements and the subsequent lattice reconfiguration. It has been found that the sintering conditions described above for a length of time of 5 to 10 hours is sufficient to achieve partial substitution means that a percentage less than 100% of the Li and/or B are substituted by the additives introduced above.

Step 3. The resulting sintered block of partially substituted material is crushed and ball milled so as to achieve a final average particle size of between about 20 to about 100 nanometers or less. As demonstrated by the data discussed below, during the final ball milling step, catalysts such as TiCl₃ and TiO₂ may be added and which provide for additional improvements in the kinetics and properties of hydrogen absorption and release.

### EXAMPLE 1

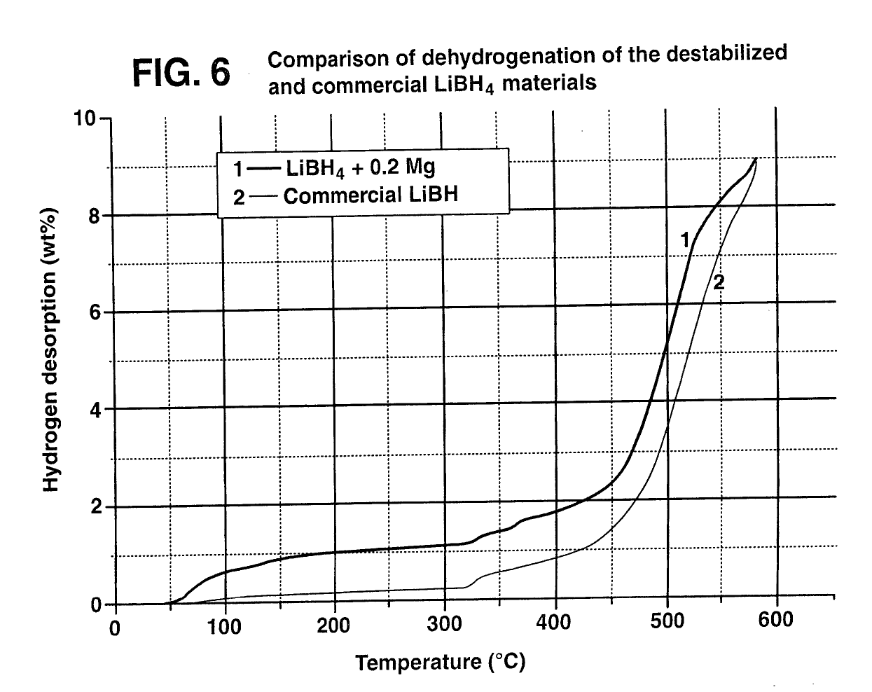

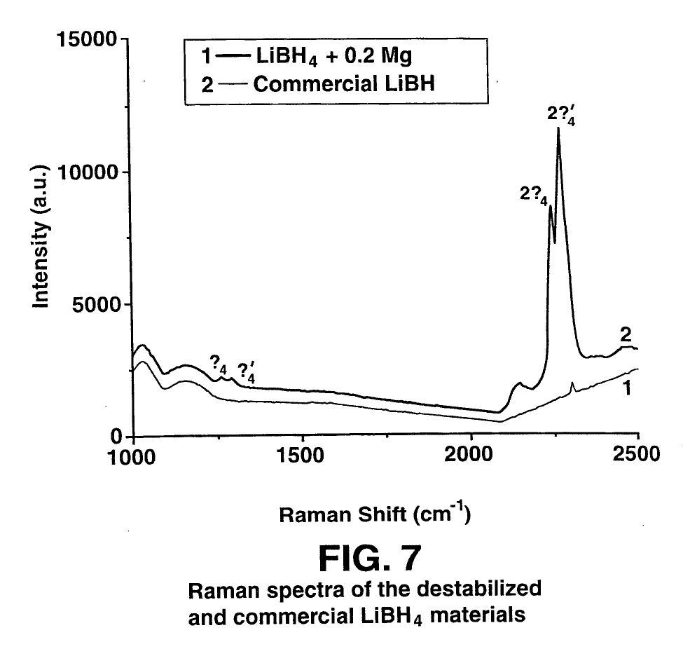

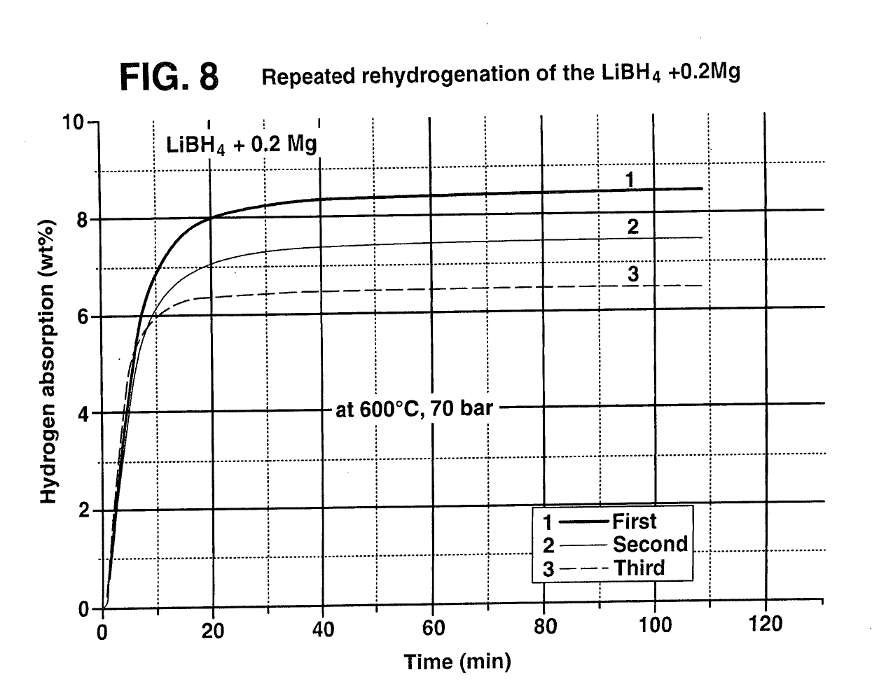

Using the protocol set forth above, LiBH₄ was mixed with 0.2 molar magnesium and used to obtain the partial substitution. As seen in reference to FIGS. 6 through 8, the destabilized material LiBH₄+0.2Mg releases hydrogen at 60° C. comparing with the commercial pure LiBH₄ that releases hydrogen at 325° C. At room temperature, two Raman active internal BH₄⁻¹ vibrations v₄ and v′₄ occur at 1253 and 1287 cm⁻¹ respectively, and two overtones 2v₄ and 2v₄′ at 2240 and 2274 cm⁻¹, respectively as spectrum 2 shows in FIG. 7. However, the V₄ v′₄, and 2v₄ stretching disappears from the spectrum after the addition of the destabilized LiBH₄+0.2 Mg. The 2v₄′ stretching is weakened and shifted to 2300 cm¹ as the spectrum 1 shows and is indicative that the B—H binding strength is reduced by partial LI⁺¹ substitution. The weakened bond results in a lower dehydriding temperature. As further seen in reference to FIG. 8, the partially substituted LiBH₄ material is able to undergo multiple cycles of rehydrogenation.

### EXAMPLE 2

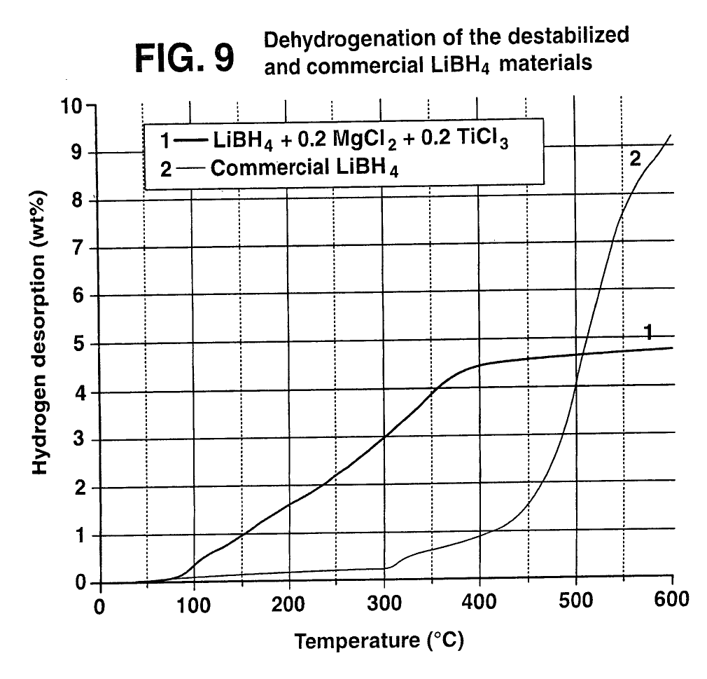

LiBH₄ was combined with 0.3 MgCl₂ plus 0.2 molar TiCl₃ and is subjected to the MTDP substitution process described above. As seen from data set forth in FIG. 9, the partially substituted product has improved hydrogen desorption release properties in terms of temperature and percent of hydrogen released at temperatures below 500° C. when compared to a commercial LiBH₄.

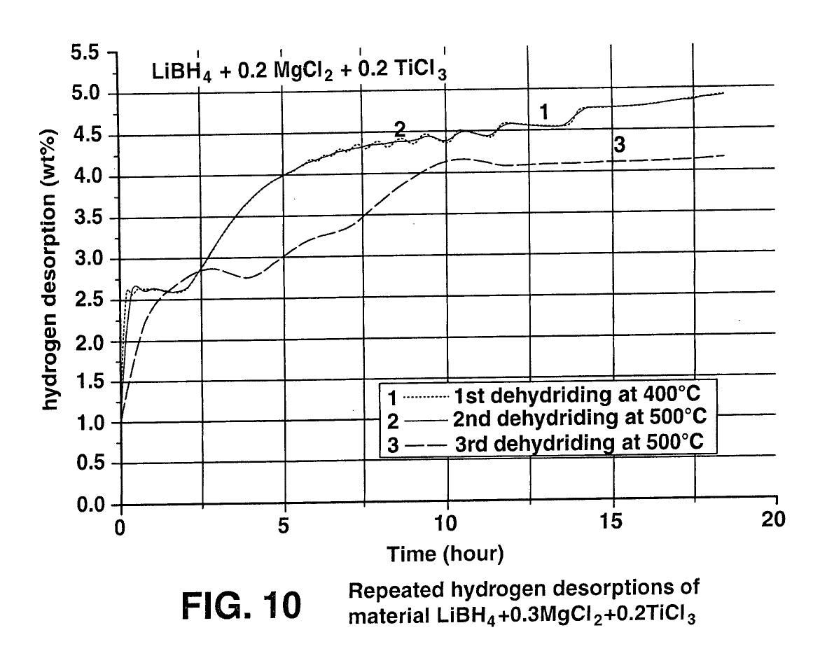

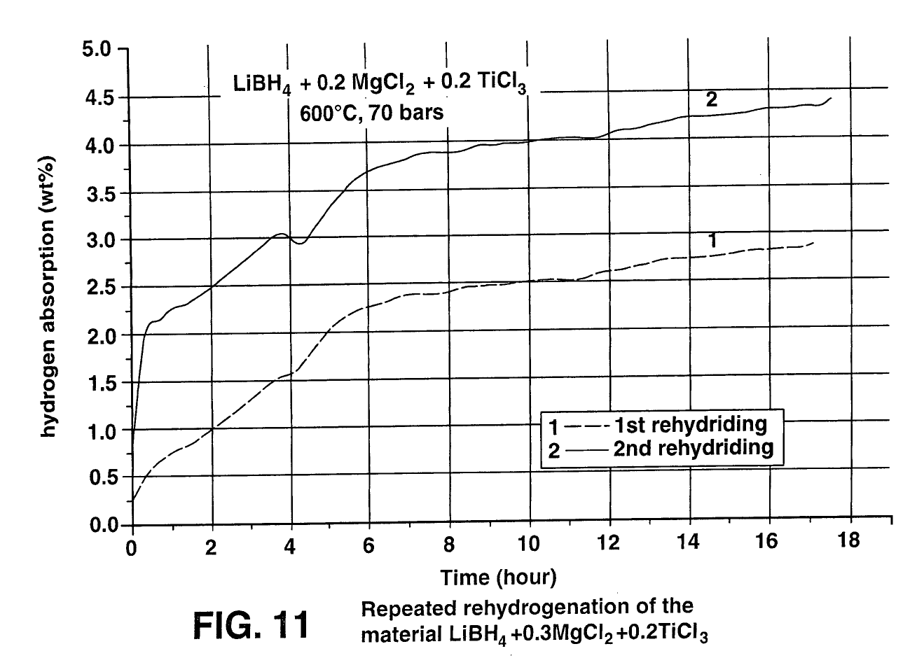

As set forth in FIGS. 10 and 11, data is set forth showing the repeated desorption and rehydrogenation capabilities respectively of the partially substituted LiBH₄.

### EXAMPLE 3

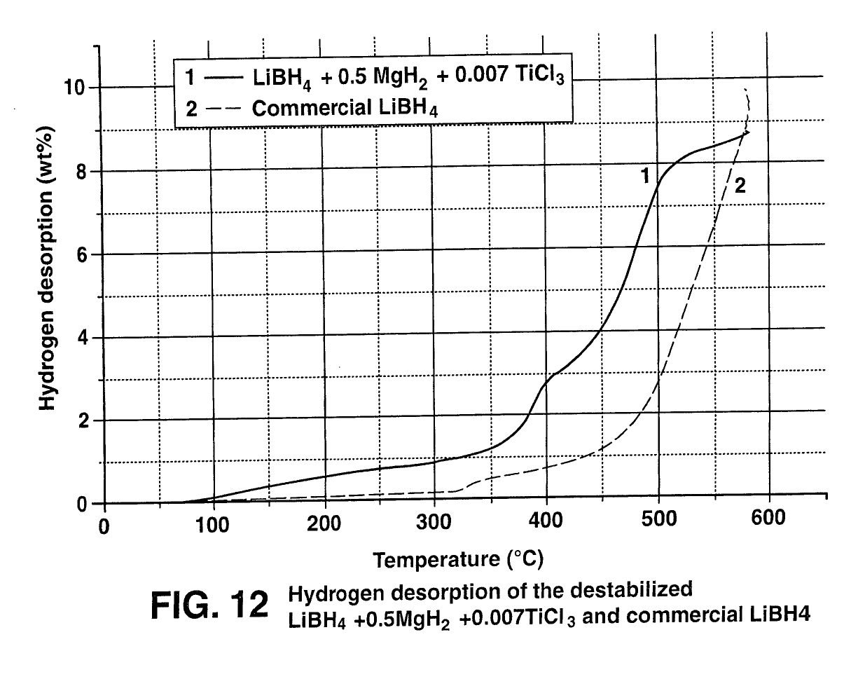

LiBH₄ was mixed with 0.5 MgH₂ plus 0.007 TiCl₃ and processed according to the MTDP substitution steps described above. Set forth in FIG. 12 is the hydrogen desorption data of the resulting product at the indicated temperatures.

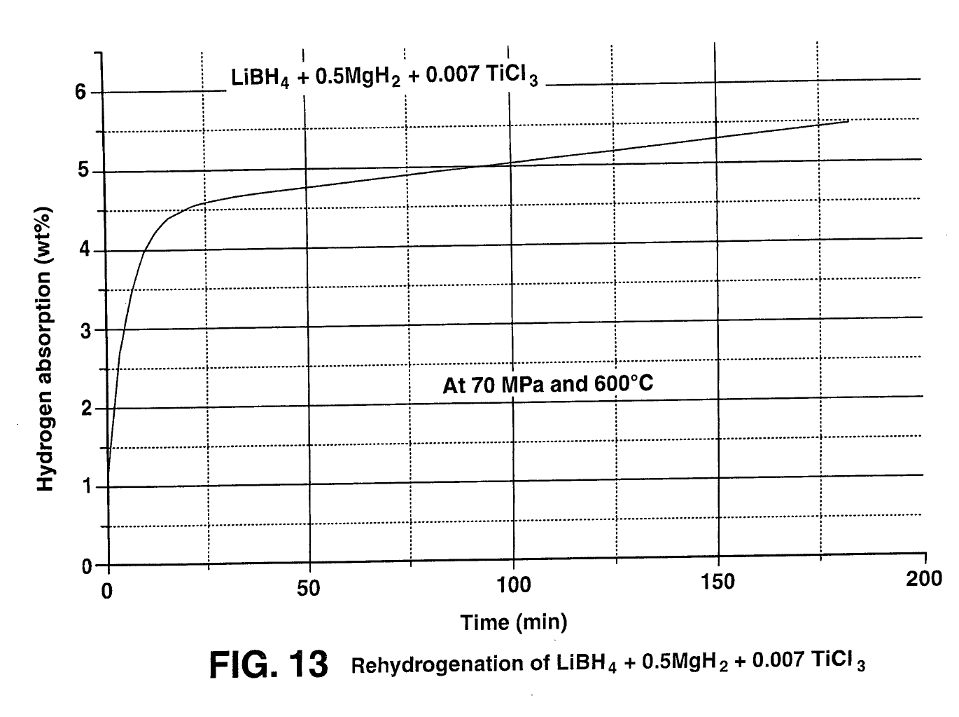

In FIG. 13, rehydrogenation data of the partially substituted LiBH₄ is set forth.

### EXAMPLE 4

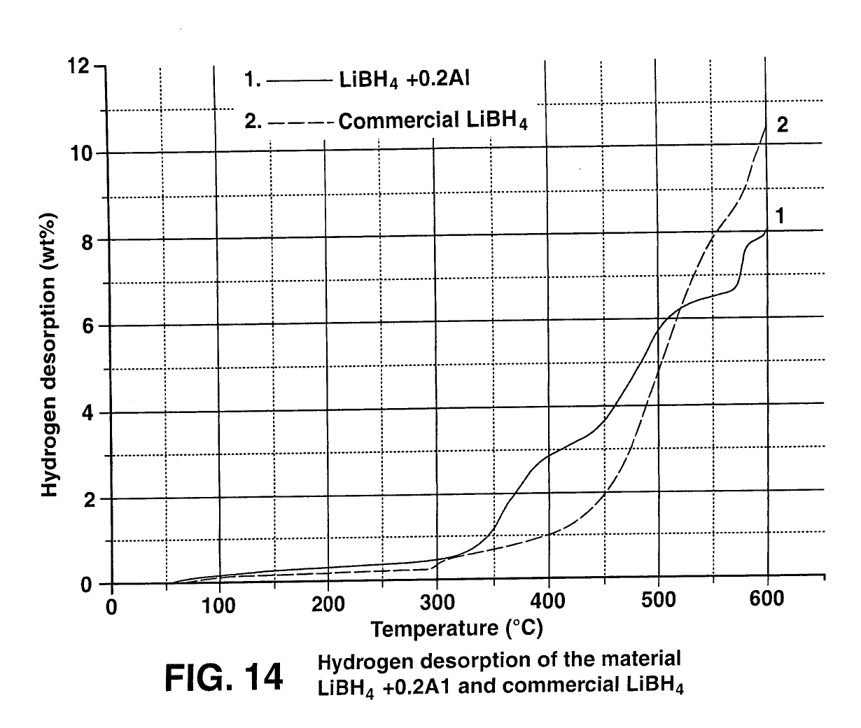

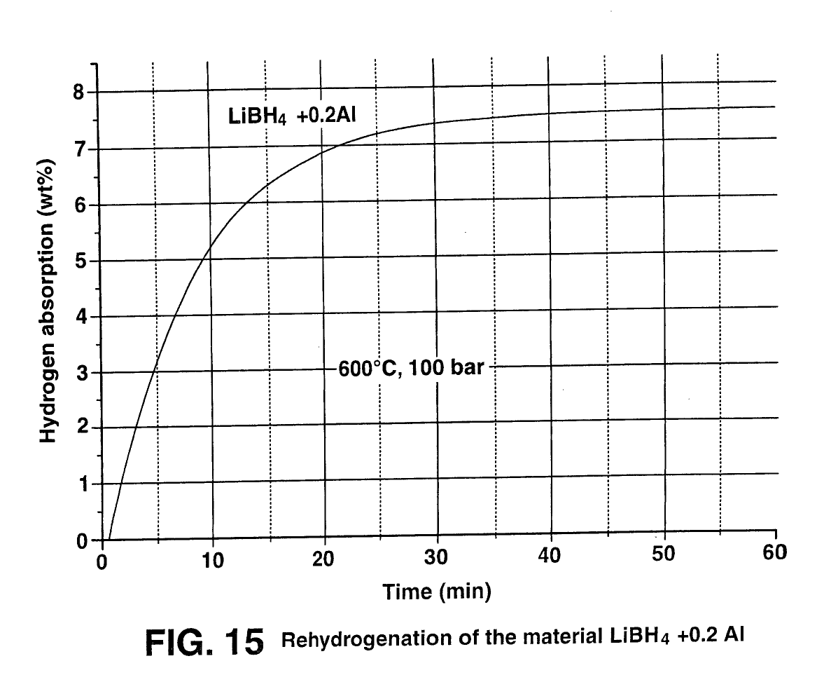

LiBH₄ at 80wt % was combined with 0.2 molar Al and treated with the MTDP substitution protocol described above. As set forth in FIGS. 14 and 15, the data on hydrogen desorption and rehydrogenation respectively is provided.

### EXAMPLE 5

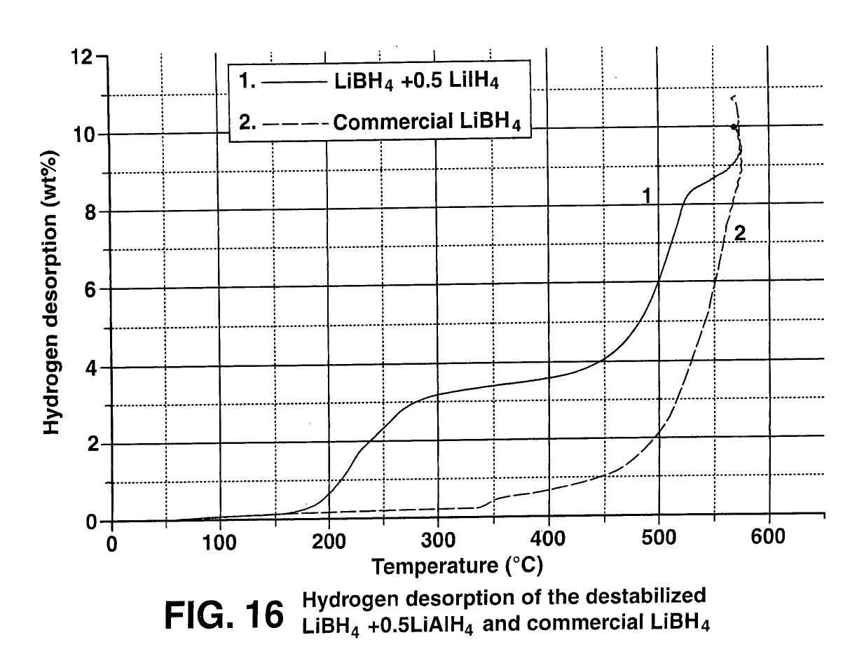

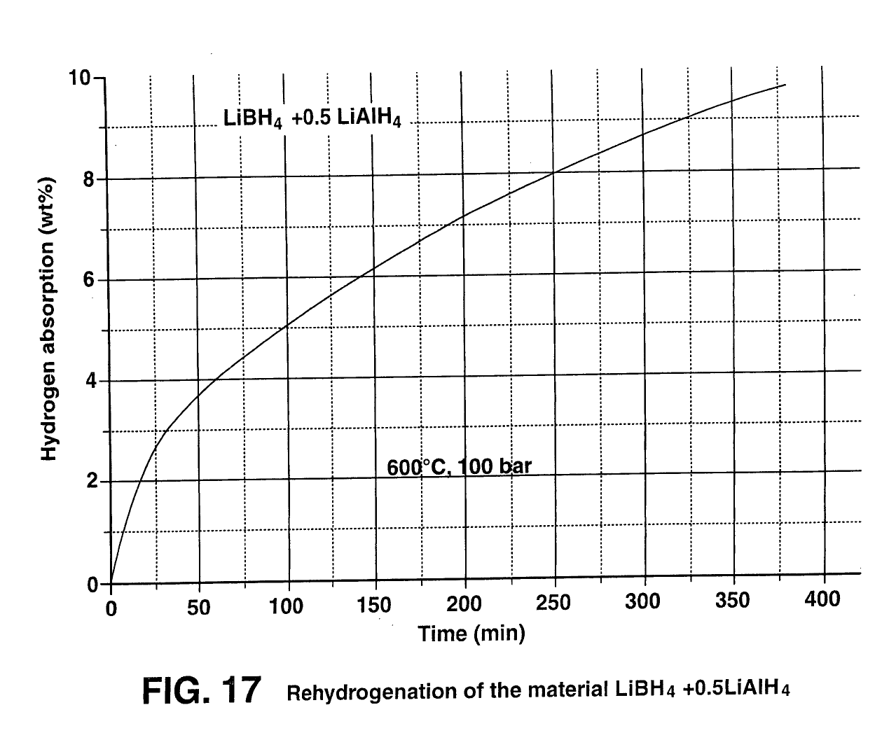

LiBH₄ was combined with 0.5 LiAlH₄ and subjected to the MTDP substitution protocol described above. As seen in reference to FIGS. 16 and 17, the respective hydrogen desorption and rehydrogenation properties of the partially substituted LiBH₄ are provided.

As seen from the above examples, it is possible to use destabilization agents to partially substitute a percentage of either Li atoms or B atoms in LiBH₄ (or both atoms) and thereby achieve a lower dehydriding temperature than is otherwise possible using non-substituted LiBH₄. In addition, as noted by the data set forth in the Figures, favorable dehydriding and rehydriding kinetics can be obtained using the partial substitution protocol along with the optional addition of catalysts such as TiCl₃ or TiO₂.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, or in part. Therefore, the spirit and scope of the appended claims should not be limited to the description of the preferred versions contained therein.

That which is claimed:

1. A process of forming a hydrogen storage material comprising the steps of:
providing a quantity of an alkali borohydride;
mixing with the alkali borohydride a substitution agent selected from the group consisting of alkali earth elements, metal chlorides, metal hydrides, complex hydrides, and mixtures thereof;
ball milling the alkali borohydride with said substitution agent;
sintering the ball milled mixture of said metal borohydride with said substitution agent at a temperature below the melting point of said metal borohydride and at a hydrogen pressure greater than the decomposition pressure of the metal borohydride at said temperature, thereby achieving a solid diffusion substitution between said substitution agent, a metal component of said metal borohydride and thereby providing a sintered block of partially substituted borohydride;
crushing and ball milling said block of partially substituted borohydride so as to achieve an average particle size of between about 20 nanometers to about 100 nanometers; and,
optionally introducing a catalyst during said ball milling of said partially substituted borohydride.

2. The partially substituted metal borohydride made according to the process of claim 1.

3. A process of forming a metal borohydride comprising the steps of:
providing a supply of metal borohydride;
substituting metal cations of the metal borohydride with metal cations having a lower metallic ion strength, thereby lowering the stability of the boron to hydrogen bonds in a [BH₄]⁻¹ tetrahedron;
optionally substituting boron atoms in the tetrahedron with other elements selected from the group consisting of Al, Ga, In, Tl, and combinations thereof;
thereby providing a substituted metal borohydride having improved hydrogen kinetics.

4. The process according to claim 1 wherein said substituted hydrogen storage material may be rehydrided.

5. The process according to claim 1 wherein when said hydrogen storage material is rehydrided, said hydrogen storage material thereafter reversibly releases at least about 8wt % hydrogen.

6. The hydrogen storage material according to claim 3 wherein the amount of hydrogen released following rehydriding is at least about 8wt % hydrogen.

7. The process according to claim 1 wherein said alkali borohydrides are selected from the group consisting of lithium borohydride, sodium borohydride, potassium borohydride, or combinations thereof.

8. The process according to claim 3 wherein said alkali borohydrides are selected from the group consisting of lithium borohydride, sodium borohydride, potassium borohydride, and combinations thereof.

9. The process according to claim 1 wherein said alkali earth elements consisting of magnesium, calcium, strontium, barium, aluminum, and mixtures thereof.

10. The process according to claim 1 wherein said metal chlorides are selected from the group consisting of MgCl₂, CaCl₂, SrCl₂, BaCl₃ and combinations thereof.

11. The process according to claim 1 wherein said metal hydrides are selected from the group consisting of MgH₂, AlH₃, CaH₂, TiH₂, ZrH₂ and combinations thereof.

12. The process according to claim 1 wherein said complex hydrides are selected from the group LiAlH₄, NaAl
